(19) United States
(12) Patent Application Publication
(10) Pub. No.: US 2020/0156954 A1
(43) Pub. Date: May 21, 2020

(54) METHOD FOR INCREASING THE MECHANICAL STABILITY OF POTASSIUM CHLORIDE COMPACTED MATERIAL

(71) Applicant: K+S Minerals and Agriculture GmbH, Kassel (DE)

(72) Inventors: Guide Baucke, Schenklengsfeld OT Wippershain (DE); Sebastian Kopf, Bad Salzungen (DE); Paul Meissner, Graz (AT)

(73) Assignee: K+S Minerals and Agriculture GmbH, Kassel (DE)

(21) Appl. No.: 16/634,279

(22) PCT Filed: Jul. 27, 2018
(86) PCT No.: PCT/DE2018/000225

§ 371 Date: Jan. 27, 2020

(30) Foreign Application Priority Data
Jul. 28, 2017 (DE) 10 2017 007 105.5

(51) Int. Cl. C01D 3/22; C01D 3/04

(52) U.S. Cl. CPC C01D 3/22; C01P 2004/64; C01D 3/04

(57) ABSTRACT

A method can increase the mechanical stability of compacted potassium chloride granules. The method can include applying water in an amount of 0.1 to 0.4 wt. %, based on the mass of the freshly produced compacted potassium chloride granules, onto the surface of the freshly produced compacted potassium chloride granules while they are still hot.

The present invention relates to a method for increasing the mechanical stability of compacted potassium chloride granules, especially of coarse compacted granules, in which at least 80 wt % of the particles of the compacted granules have a grain size of at least 5 mm.

As a raw material of the chemical industry, potassium chloride has diverse possibilities for use, including its use as an auxiliary in numerous industrial processes. In the chemical industry, potassium chloride is employed, for example, in the production of potash fertilizers, as a raw material for producing potassium compounds utilized industrially, such as potassium hydroxide and potassium carbonate, or potassium alloys such as NaK, as an electrolyte in melt flux electrolysis, or as a conductive salt in electroplating.

Potassium chloride is typically extracted in underground mines by conventional mineworking, by solution mining, or by solar evaporation of salt waters. On its extraction, potassium chloride is recovered in a comparatively fine form. The grain size of such a product, such as of a product from the hot leaching process, for example, is typically below 2 mm (d₉₀ value, determined by sieve analysis; i.e., 90 wt % of the particles have a grain size below 2 mm). Potassium chloride is frequently marketed in a coarse form, in the form, for example, of pellets or in the form of compacted granules, since these forms have advantageous handling qualities. For instance, as compared with fine potassium chloride, coarse potassium chloride has a very much lower tendency to form dust, is more stable in storage, and has less of a propensity toward caking.

Coarse potassium chloride is produced, for example, by pressure agglomeration, in other words by compaction or compression of fine potassium chloride, and is therefore frequently also referred to as compacted granules. The particles of such granules have an irregular shape. In contrast to potash fertilizer pellets, compacted granules are coarser and frequently have grain sizes of at least 5 mm (undersize 5 mm<20 wt %, determined by sieve analysis).

Compacted potassium chloride granules are comparatively unstable to mechanical load. On exposure to mechanical forces, as for example when depositing or withdrawing the pellets into or from silos or beds, or on transshipment of the pellets, there is severe grain destruction, which is manifested in an increase in the fraction of potassium chloride particles having grain sizes below 5 mm and in the significant formation of potassium chloride particles having a size of below 2 mm. The formation of small particles presents problems, since they increase the caking propensity of the compacted potassium chloride granules and may hinder handling, due to formation of dusts. These problems particularly affect compacted potassium chloride granules having a high potassium chloride content.

It is fundamentally known practice to improve the mechanical strength of compacted potassium chloride granules through addition of strengthening additives, called binders. Typical binders are gelatin, starch, molasses, lignosulfonates, phosphates, metasilicates, lime, and clay minerals. The choice of the binder will in general critically influence the properties of the compacted granules, especially their mechanical strength (abrasion, hardness), hygroscopic properties, and dusting tendency. A disadvantage, however, is that such binders raise the costs of producing the compacted granules. Moreover, the binders may limit the possible uses of these granules. Organic binders in particular, for example, may be a disadvantage if the compacted granules are employed in electrolysis, in the production of potassium hydroxide, for example. There is a general requirement in such cases for TOC values of less than 10 ppm, more particularly not more than 5 ppm. The inorganic binders as well may prove problematic as regards the service properties of the compacted granules.

DD 136956 discloses improving the grain stability of potash fertilizer pellets by first dedusting them in a fluidized bed, wetting the dedusted pellets with 0.5 to 2 wt %, more particularly 1 wt %, of water, and then drying the humidified pellets to a residual water content of preferably 0.1 to 0.2 wt %. The pellets used in DD 136956 have grain sizes between 1 to 4 mm and therefore, by comparison with compacted granules, are less sensitive to grain destruction by mechanical exposure. To improve the freedom from dust, the pellets thus treated are treated with a dust binder agent in the form of a mineral oil. Consequently these pellets are no longer suitable for the majority of applications in chemical processes.

It is an object of the present invention, therefore, to improve the mechanical stability of compacted potassium chloride granules without any recourse to conventional binders. The intention more particularly was to obtain an improvement for coarse compacted granules having a potassium chloride content of at least 98 wt %, based on the nonaqueous constituents of the compacted granules.

It has surprisingly been found that the mechanical stability of compacted potassium chloride granules can be improved by means of a method wherein water in an amount of 0.1 to 0.4 wt %, more particularly in an amount of 0.25 to 0.35 wt %, based on the mass of the freshly produced compacted potassium chloride granules, is applied to the surface of the freshly produced compacted potassium chloride granules while they are still hot.

The invention accordingly provides a method for increasing the mechanical stability of compacted potassium chloride granules, which is characterized in that water in an amount of 0.1 to 0.4 wt %, more particularly in an amount of 0.25 to 0.35 wt %, based on the mass of the freshly produced compacted potassium chloride granules, is applied to the surface of freshly produced compacted potassium chloride granules while they are still hot.

The method of the invention requires no conventional binders and also no dust binders. The comparatively small amounts of water are sufficient to achieve sufficient strengthening of the compacted granules. Larger quantities of water are unnecessary. They lead in general to other drawbacks, such as a greater caking tendency on the part of the compacted granules, for example. The method is simple to perform, since the water can be applied in a simple way, by spraying, for example, to the compacted granules. Costly and inconvenient mixing apparatus is not required for this purpose. In the method of the invention, moreover, in contrast to the methods described in the prior art for treating pellets with water, there is no need for a subsequent drying step.

The method of the invention is suitable especially for improving the mechanical stability of coarse compacted granules, i.e., of those freshly produced compacted granules in which at least 80 wt % of the compacted potassium chloride granules have grain sizes of at least 5 mm, e.g. grain sizes in the range from 5 to 40 mm. In particular, correspondingly, the present invention relates to a method for increasing the mechanical stability of compacted potassium chloride granules wherein at least 80 wt % of the compacted potassium chloride granules have grain sizes of at least 5 mm, e.g., grain sizes in the range from 5 to 40 mm.

The grain sizes reported here and hereinafter relate to the values as determined by sieve analysis in accordance with DIN 66165:2016-08. According to DIN 66165:2016-08, the mass fractions of the respective grain sizes or grain size ranges are ascertained by fractionating the disperse material using a plurality of sieves, by means of machine sieving, in precalibrated systems. In relation to the particle size or grain size, all particulars in % should be understood as wt %.

The method of the invention is suitable especially for improving the mechanical stability of compacted potassium chloride granules having a high potassium chloride content. The freshly produced compacted potassium chloride granules, also referred to below as the compacted potassium chloride granules to be treated, preferably have a KCl content of at least 98.0 wt %, e.g., in the range from 98.0 to 99.9 wt %, more particularly at least 98.5 wt %, e.g., in the range from 98.5 to 99.9 wt %, especially at least 99.0 wt %, e.g., in the range from 99.0 to 99.9 wt %, based in each case on the nonaqueous constituents of the compacted potassium chloride granules. Besides potassium chloride, the freshly produced compacted potassium chloride granules may also comprise other constituents, different from potassium chloride and from water. These constituents more particularly are sodium chloride, bromides of sodium or of potassium, or alkaline earth metal halides such as magnesium chloride and calcium chloride, and their oxides. The total amount of such constituents will generally not exceed 2.0 wt %, more particularly 1.5 wt % and especially 1.0 wt %, and is situated typically in the range from 0.1 to 2.0 wt %, more particularly in the range from 0.1 to 1.5 wt %, and especially in the range from 0.1 to 1 wt %. The advantages according to the invention come into play especially when the fraction of alkaline earth metal compounds is not more than 2000 ppm, calculated as oxides and based on the nonaqueous constituents of the freshly produced compacted potassium chloride granules.

The advantages according to the invention also come into play especially when the freshly produced compacted potassium chloride granules contain no or substantially no conventional binders. The fraction of conventional binders is therefore more particularly below 0.1 wt %, especially below 0.05 wt %, based on the nonaqueous constituents of the compacted potassium chloride granules.

More particularly, the freshly produced compacted potassium chloride granules to be treated contain no or substantially no organic binders or other organic impurities, with the freshly produced compacted potassium chloride granules more particularly, based on their total mass, containing less than 10 ppm, more particularly not more than 5 ppm, of organic carbon (TOC value), determined in a method based on that described in DIN EN 15936:2012, and calculated as elemental carbon. In the method of the invention, accordingly, with preference organic strengtheners or dust binders will be added to the compacted potassium chloride granules neither during their production nor before or after the application of the water.

As already mentioned in the introduction, the production of compacted potassium chloride granules includes compression of fine potassium chloride. This operation is also referred to as pressure agglomeration or compacting.

In the pressure agglomeration, it is usual to use a fine potassium chloride raw material, in which at least 90 wt %, more particularly at least 95 wt %, of the particles of the potassium chloride raw material have a grain size of not more than 2 mm. More particularly at least 90 wt %, especially at least 95 wt %, of the particles of the fine potassium chloride have a grain size in the range from 0.01 to 2 mm.

The fine potassium chloride, hereinafter also potassium chloride raw material, typically has levels of impurities that are comparable with those of the freshly produced compacted potassium chloride granules, since generally no further constituents are added during compacting to the fine potassium chloride. With preference, accordingly, the fine potassium chloride used for compacting has a KCl content of at least 98.0 wt %, e.g., in the range from 98.0 to 99.9 wt %, more particularly at least 98.5 wt %, e.g., in the range from 98.5 to 99.9 wt %, especially at least 99.0 wt %, e.g., in the range from 99.0 to 99.9 wt %, based in each case on the nonaqueous constituents of the fine potassium chloride. Furthermore, the fine potassium chloride may also comprise constituents different from it. These constituents are more particularly the constituents stated in connection with the compacted granules. The advantages according to the invention come into play especially when the fraction of alkaline earth metal compounds is not more than 2000 ppm, calculated as oxides and based on the nonaqueous constituents of the fine potassium chloride.

The potassium chloride raw material usually comprises a crystalline potassium chloride which has been extracted by mineworking, or extracted via solar evaporation or solution mining, and which has been processed, for example, by evaporation, crystallization and/or by a hot leaching process, by flotation, or by a combination of these measures. In the method of the invention, further potassium chloride may also have been admixed additionally to the potassium chloride raw material. The further potassium chloride in question comprises, for example, the reject material obtained when classifying the potassium chloride pellets of the invention, said material having possibly been comminuted. In these mixtures of potassium chloride raw material and further potassium chloride, the fraction of further potassium chloride, e.g., the reject material, will in general be situated in the range from 1 to 70 wt %, based on the total mass of the amount fed in for pelletization.

Presses suitable for the compacting are in principle all presses known for similar purposes, such as die presses, strand presses, hole presses, and roll presses.

The compacting preferably takes place with use of a roll press. In roll presses, the compacting takes place in the gap between two rolls rotating counter to one another. The roll surfaces may be smooth, profiled, for example striated, corrugated or waffled, or equipped with molding wells. Any profiling of the roll surface serves in particular to improve the intake ratio into the roll gap. Frequently roll presses with a smooth or profiled roll surface will be used. In that case the primary agglomeration product is a strand in the form of a ribbon that emerges from the roll gap, this strand also being referred to as a slug.

The compression forces required for the compacting, which are typically based on the roll width and reported as linear forces, are generally in the range from 1 to 75 kN/cm, more particularly in the range from 40 to 70 kN/cm, and based on 1000 mm diameter and on an average slug thickness of 10-18 mm. In general the roll press is operated at a circumferential roll speed in the range from 0.2 to 1.6 m/s.

Compacting takes place customarily at temperatures in the range from 80 to 150° C. The temperature in question here may be that which is established owing to the action of the mechanical forces on the treated potassium chloride raw material. The material supplied to the compacting will optionally be preheated to the desired compacting temperature, or the material still has residual heat, from the drying, for example.

The pressure agglomeration may optionally be performed in multiple stages.

The pressure agglomeration of the treated potassium chloride raw material using a roll press generally affords slugs, which to adjust the particle size of the compacted granules obtained are subjected to comminution. The slugs may be comminuted in a manner known per se, and for example by grinding in devices suitable for the purpose, examples being impact crushers, impact mills or roll crushers, especially those having spiked rolls.

The compacted granules are optionally subjected to classifying, during which finer constituents are removed. Classifying may take place in a manner known per se, as for example by sieving of the comminuted material.

In accordance with the invention, water is used to treat the freshly produced compacted potassium chloride granules while they are still hot. The heat results from the energy introduced during the production of the compacted granules, such as the heat energy expended for drying, for example, or else the heat energy introduced during compressing and comminuting, which on the basis of the heat capacity of the potassium chloride is initially stored in the compacted granules and released slowly to the surroundings only after the production process.

In this context it has proven advantageous if the compacted potassium chloride granules, immediately prior to the application of the water, have a temperature of at least 70° C., more particularly at least 80° C., and especially at least 85° C. The temperature of the freshly produced, still-hot compacted potassium chloride granules immediately prior to the application of the water will typically not exceed a temperature of 140° C., more particularly 130° C., and especially 125° C. Correspondingly, the temperature of the freshly produced, still-hot compacted potassium chloride granules immediately prior to the application of the water is situated in the range from 70 to 140° C., more particularly in the range from 80 to 130° C., and especially in the range from 85 to 125° C.

The water content of the freshly produced compacted potassium chloride granules, prior to the application of the water, is typically only low, frequently not exceeding a value of 0.3 wt %, more particularly 0.2 wt %. In many cases the water content of the freshly produced compacted potassium chloride granules is situated in the range from 0.01 to 0.3 wt %, more particularly in the range from 0.02 to 0.2 wt %, based on the total mass of the compacted granules and determined via the loss on drying of the compacted granules at 105±5° C. This loss on drying is determined typically in a method based on DIN EN 12880:2000, by drying a sample to constant weight under ambient pressure at temperatures in the range of 105±5° C. Laboratory drying for the purpose of determining the water content takes place generally in a drying oven. The time needed to achieve constant weight in the case of compacted potassium chloride granules is typically below 2 h. In this case, the dry residue in %, based on the starting weight employed, is ascertained by weighing before and after drying. The loss on drying in % is obtained from the dry residue in % by subtraction from 100.

With preference the water is applied as evenly as possible to the surface of the compacted potassium chloride granules. It has proven appropriate in this context to apply the water in finely divided form, such as by spraying or in atomized form, for example, to the particles of the compacted potassium chloride granules. For this purpose it is usual to atomize or spray the water by means of one or more suitable atomizers, examples being stationary or rotating nozzles.

It has proven advantageous here if, during the application of the water, especially the atomized water, the compacted potassium chloride granules are moved, in order to achieve a more uniform application of the water to the surface of the compacted granular particles. The procedure adopted will more particularly be such that the compacted potassium chloride granules are guided in a relative movement through a spray cone or a spray curtain made up of two or more overlapping spray cones. For example, the procedure adopted for applying the water may be such that the compacted potassium chloride granules are guided, using a conveyor belt, through a region in which water is sprayed or atomized, by the generation, for example, of one or more spray cones or one or more spray curtains on the moving conveyor belt. Also possible is the generation of a region in which water is sprayed or atomized, at the transfer point between two conveyor belts, for example. In this way the application of the water to the surface of the compacted granular particles is particularly uniform. In principle it is also possible to apply the water to the surface of the compacted granular particles in mixing devices, such as drum mixers, for example. During application of the water, preference will be given to minimizing the mechanical stress on the compacted granules.

The water used for application to the compacted potassium chloride granules may in principle be pure water, e.g., deionized water, or else mains water or process water. It preferably contains extraneous constituents not at all or in insignificant amounts, aside from the inorganic salts normally present in mains or process water, so as to prevent contamination of the compacted potassium chloride granules. More particularly the water contains no organic constituents—that is, the concentration of organic impurities is in particular below 100 ppm. The total concentration of impurities in the water, i.e., the total amount of organic and inorganic nonaqueous constituents, is preferably below 1000 ppm.

The water used for application to the compacted potassium chloride granules typically has temperatures in the region of the ambient temperature, e.g., temperatures in the range from 5 to 40° C. Where appropriate it may be sensible to heat the water prior to application, to temperatures of up to 80° C., for example.

After treatment in accordance with the invention, the treated, compacted potassium chloride granules are typically sent to storage, in silos or as heaps in storehouses, for example. In principle the compacted potassium chloride granules treated with water in accordance with the invention can also be packaged, in sacks or big-bags, for example.

In comparison to untreated compacted potassium chloride granules, the compacted potassium chloride granules treated in accordance with the invention are notable for reduced sensitivity to mechanical load, as experienced, for example, during storage or withdrawal from storage or on transshipment or transportation of the compacted granules. This reduced sensitivity is manifested in less grain destruction and in reduced formation of abraded material—that is, of particles with grain sizes of below 2 mm. Accordingly, compacted potassium chloride granules treated in accordance with the invention have less of a tendency toward caking than do untreated compacted potassium chloride granules on storage, especially under pressure, of the kind occurring in heaps or on storage in silos. Surprisingly, even on storage for prolonged periods, the improved mechanical strength of the compacted granules is retained, and so the mechanical loads that do occur on withdrawal from storage or on transshipment cause less grain destruction to the compacted potassium chloride granules treated in accordance with the invention, even after prolonged storage, in comparison with untreated compacted potassium chloride granules.

The examples which follow serve likewise to illustrate the invention, but should not be understood as imposing any limitation.

### EXAMPLES

The experiments below used potassium chloride raw material having the following specification: KCl content of 99 wt % (=62.5% K₂O), total Ca+Mg content around 0.01 wt %. The residual moisture content of the (moist) potassium chloride raw material is generally 5.7-6.2 wt %.

Grain size distribution:

| | |
|---|---|
| 1.1 wt % | <0.09 mm |
| 6.3 wt % | 0.09 to <0.16 mm |
| 10.1 wt % | 0.16 to <0.212 mm |
| 8.8 wt % | 0.212 to <0.25 mm |
| 68.5 wt % | 0.25 to <0.5 mm |
| 5.2 wt % | >0.5 mm |

For the production of compacted potassium chloride granules, the moist potassium chloride raw material was sent to drying at around 135° C. After that, the raw material, together where appropriate with the press reject material in the comminution/fractionation, was fed to the presses. The quantities processed amount to around 40 t/h of potassium chloride raw material.

For the pressure agglomeration in production, a roll press with reject-material circulation was used. The construction of the roll press is as follows: two rolls rotating counter to one another have waffle profiling on the roll surface (typical roll diameter 1150 mm, typical working width 1000 mm, gap width typically around 15 mm). The press was operated with a linear force of around 70 kN/cm and a roll speed of 0.7 m/s. The potassium chloride raw material was supplied generally by means of a central chain conveyor and the stuffing screws arranged above the presses.

The slugs produced in the roll press were comminuted by means of a roll crusher. The material was then classified with a conventional sieving apparatus, the fraction with grain size >5 mm (product) was separated off, and the fraction with grain size <5 mm was recycled to the feed. The respective fractions were discharged from the sieving apparatus with a conveyor belt.

Immediately after discharge from the sieving apparatus, the compacted granules had a temperature of 90 to 110° C. and a loss on drying of less than 0.1 wt %.

Immediately after leaving the sieving apparatus, the compacted granules thus produced, on the conveyor belt, were sprayed with water, using a flat jet nozzle. The water was mains water with a hardness of 13.8 dH [German hardness]. The nozzle was set so as to generate a flat spray cone with an opening angle of 120°. The conveyor belt speed and the amount of water applied were adjusted such that the quantity applied was about 0.3 wt %, based on the compacted granules guided through the spray cone. Over a prolonged period, a total of 22 samples, each of 10-15 kg, were withdrawn, via a sampling hatch, from the resultant compacted potassium chloride granules. 2-3 kg of each of the samples were divided off and, for determining the grain size distribution, were sieved for 5 min. on a sieving machine (EML 450 digital plus from Haver & Boecker).

The grain size distribution of the resultant compacted potassium chloride granules was as follows (average over 22 samples):

| | |
|---|---|
| 7.6 wt % | <5 mm (4.8 wt % <2 mm, 2.8 wt % 2 to <5 mm) |
| 4.6 wt % | 5 to 6.3 mm |
| 13.1 wt % | >6.3 to 8 mm |
| 14.4 wt % | >8 to 10 mm |
| 15.5 wt % | >10 to 12.5 mm |
| 15.3 wt % | >12.5 to 16 mm |
| 14.2 wt % | >16 to 20 mm |
| 8.6 wt % | >20 to 25 mm |
| 6.7 wt % | >25 mm. |

The resulting compacted granules were subsequently placed in storage as a heap in a storehouse, via the conveyor belt. After seven days of storage, the material was withdrawn using a digger. A successive 21 samples, each of 10-15 kg, were again taken from the material withdrawn from storage. 2-3 kg of each of the samples were divided off, and the fraction of particles having sizes >2 mm and >5 mm in these sub-samples was determined by sieve analysis in the manner described above. Table 1 below compiles the corresponding values.

For purposes of comparison, compacted potassium chloride granules were produced in the manner and under the conditions described above, with the sole difference that the compacted granules were not sprayed with water.

TABLE 1
Grain destruction of compacted potassium chloride granules before
placement in storage and after withdrawal from storage.

| | Comparative example, no | | Example with 0.3 wt % | |
|---|---|---|---|---|
| | applied amount of water | | applied water | |
| Pre-storage grain | <5 mm | 10.3 wt % | <5 mm | 7.6 wt % |
| destruction* | <2 mm | 7.1 wt % | <2 mm | 4.8 wt % |
| Grain destruction | <5 mm | 30.3 wt % | <5 mm | 18.5 wt % |
| on withdrawal | <2 mm | 17.4 wt % | <2 mm | 9.4 wt % |
| from storage** | | | | |

*immediately after production, average over 22 samples
**after seven days of storage and withdrawal, average over 21 samples

The advantageous mechanical stability is also retained on transportation. Accordingly, the compacted granules withdrawn from storage were first loaded onto a truck, then transshipped to a transport ship, and subsequently unloaded. During these procedures it was found that the treated compacted granules in comparison to the untreated compacted granules had a more than 2.5 times smaller fraction of particles having grain sizes of below 5 mm.

The grain stability may also be determined via the abrasion of the compacted granules by means of a drum test, which is based on the procedures described in DIN 51717 or ISO 3271. In this test, particles having grain sizes of below 5 mm are formed as a result of the mechanical load on the compacted granules. The smaller the fraction of particles having grain sizes of below 5 mm or below 2 mm, respectively, the greater the mechanical stability of the compacted granules.

For this purpose, in each case 2.0±0.5 kg of the above-described compacted potassium chloride granules, from the fractions having grain sizes in the 10-20 mm range, were placed into a cylindrical drum with horizontal rotatable mounting, the drum having an internal diameter of 500 mm, a width (cylinder height) of 500 mm, and two lifting bars with a height of 80 mm, mounted at an offset of 180° internally on the lateral surface of the cylinder. To subject the compacted granules to mechanical stress, the drum was rotated at 25 rpm for eight minutes (a total of 200 revolutions). The contents of the drum were then sieved in a sieving machine (EML 450 digital plus from Haver & Boecker) for five minutes, onto a sieve having a mesh size of 5 mm, beneath which was a sieve having a mesh size of 2 mm.

After treatment in the drum, the compacted potassium chloride granules produced in the manner described above and treated with 0.3 wt % of water contained 18.4 wt % of particles having a size of below 5 mm. The compacted potassium chloride granules produced without water treatment, for purposes of comparison, contained 27.8 wt % of particles having a size of below 5 mm, after treatment in the drum.

1: A method for increasing mechanical stability of compacted potassium chloride granules, the method comprising:
applying water in an amount of 0.1 to 0.4 wt %, based on the mass of the compacted potassium chloride granules when they are freshly produced,
wherein the water is applied to the surface of the compacted potassium chloride granules while they are freshly produced and still hot.

2: The method as claimed in claim 1, wherein at least 80 wt % of the compacted potassium chloride granules, prior to the application of the water and when they are freshly produced, have grain sizes of at least 5 mm, determined by sieve analysis according to DIN 66165:2016-08.

3: The method as claimed in claim 1, wherein the coarse compacted potassium chloride granules, prior to the application of the water and when they are freshly produced, have a temperature of at least 70° C.

4: The method as claimed in claim 1, wherein the coarse compacted potassium chloride granules when they are freshly produced contain less than 10 ppm of organic carbon (TOC value), determined according to DIN EN 15936:2012 and calculated as elemental carbon.

5: The method as claimed in claim 1, wherein the compacted potassium chloride granules, prior to the application of the water and when they are freshly produced, have a water content of 0.01 to 0.3 wt %, determined by way of loss on drying at 105° C.

6: The method as claimed in claim 1, wherein the compacted potassium chloride granules when they are freshly produced have a KCl content of at least 98 wt %, based on nonaqueous constituents of the compacted potassium chloride granules.

7: The method as claimed in claim 1, wherein production of the compacted potassium chloride granules comprises pressure agglomeration of fine potassium chloride with a roll press at elevated temperature.

8: The method as claimed in claim 7, wherein the pressure agglomeration produces resultant slugs, and wherein the pressure agglomeration is followed by comminution of the resultant slugs.

9: The method as claimed in claim 1, wherein organic strengtheners or dust binders are not added to the compacted potassium chloride granules during production, nor are organic strengtheners or dust binders added to the compacted potassium chloride granules before or after application of the water.

10: The method as claimed in claim 1, wherein the water is applied in atomized form to the compacted potassium chloride granules while they are moving.

11: The method as claimed in claim 1, wherein the compacted potassium chloride granules contain less than 27.8 wt % of particles having a size of below 5 mm, after the water is applied and after treatment according to DIN 51717.

12: The method as claimed in claim 1, wherein the compacted potassium chloride granules contain 18.4 wt % or less of particles having a size of below 5 mm, after the water is applied and after treatment according to DIN 51717.

13: The method as claimed in claim 1, wherein the method does not comprise a drying step after the water is applied.

14: The method as claimed in claim 1, wherein a content of alkaline earth metal compounds in the compacted potassium chloride granules, when they are freshly produced, is not more than 2000 ppm, calculated as oxides and based on nonaqueous constituents of the compacted potassium chloride granules.

15: The method as claimed in claim 1, wherein a content of a conventional binder or binders in the compacted potassium chloride granules is below 0.1 wt %, based on nonaqueous constituents of the compacted potassium chloride granules.
